(19) United States
(12) Patent Application Publication
(10) Pub. No.: US 2024/0403517 A1
(43) Pub. Date: Dec. 5, 2024

(54) PETRI-NETWORK-BASED MODELING AND RECOGNITION OF A MALFUNCTION IN A SENSOR SYSTEM

(71) Applicant: Robert Bosch GmbH, Stuttgart (DE)

(72) Inventor: Stephan Roemer, Forst (DE)

(21) Appl. No.: 18/675,195

(22) Filed: May 28, 2024

(30) Foreign Application Priority Data
Jun. 5, 2023 (DE) 10 2023 205 246.6

(51) Int. Cl. G06F 30/22; G06F 119/02

(52) U.S. Cl. CPC G06F 30/22; G06F 2119/02

(57) ABSTRACT

A method for generating a reachability graph for recognizing a malfunction of a sensor system. The sensor system is operable with software configured to execute a number of tasks in a certain order. The method includes: generating a Petri net containing information about the tasks of the software of the sensor system and their order, each task being described by a relevant transition of the Petri net, which is executed by the software if required condition(s) for that task are fulfilled; initializing the Petri net by an initial marking, by corresponding conditions for executing at least one or more tasks of the software being set as fulfilled; propagating along the Petri net starting from the initial marking by determining tasks of the software for which the required conditions are fulfilled at each relevant propagation step; generating a reachability graph with nodes, which include information about fulfilled required conditions.

### FIELD

The present invention relates to techniques for generating a reachability graph for recognizing a malfunction of a sensor system. Related aspects concern a method for recognizing a malfunction of a sensor system using a reachability graph, to corresponding modules, to a sensor system, and to a computer program.

### BACKGROUND INFORMATION

Sensor systems (based, for example, on cameras, radars, lidars or other sensors) are increasingly being used in various technical apparatuses to ensure the detection of objects and structures and to enable the functions of such apparatuses to be carried out. In many cases, for example if a sensor system is used for semi-autonomous, autonomous or assisted driving of a vehicle, traditional image processing algorithms are combined with artificial intelligence methods in order to ensure robust object recognition, for example objects detected by a camera. For example, sensor systems comprise machine learning systems (for example those that use artificial neural networks) that are extensively trained and/or validated based on known data sets, in order to provide plausible output data (i.e., unknown output data) for any given input data (for example, within the framework of image processing). In some cases of the related art, for example in connection with driver assistance systems, semi-automated or automated driving, the correct functional behavior of the apparatus (for example, the correct behavior of an ABS emergency braking function) in which the sensor system is used can be verified by large validation data sets by means of hardware-in-the-loop simulation (“HiL” simulation), which have usually been recorded beforehand (for example video streams, measured radar sensor reflections, or lidar point cloud recordings).

On the other hand, the stability or operating state of the sensor system, also in conjunction with the apparatus coupled to this sensor system, is usually evaluated by stress testing the system, for example using an expert estimate for certain situations such as driving scenarios that cause the highest possible system computing load (for example, CPU utilization, RAM bandwidth transfers, runtime/utilization of individual system parts).

However, some methods of the related art say nothing about the extent to which the operating states of the sensor system (or, in other words, its internal states) have been covered by the validation data sets previously created and subsequently processed by the sensor system (for example, for training artificial neural networks). In addition, some methods of the related art are not capable of determining whether the new data sets generated by the sensor system (for example, new video data detected by a vehicle camera in real time while driving in a new environment) can cause a malfunction of the sensor system.

Therefore, there is a need to develop new techniques for recognizing a malfunction for sensor systems that can solve some or all of the above problems.

### SUMMARY

A first general aspect of the present invention relates to a method for generating a reachability graph for recognizing a malfunction of a sensor system, wherein the sensor system is operable with software that is designed to execute a number of tasks in a specified order. According to an example embodiment of the present invention, the method comprises generating a Petri net that contains information about the number of tasks of the sensor system software and their order. Each task of the first aspect is described by a relevant transition of the Petri net, which is executed by the software, if one or more required conditions for this task are fulfilled. For this purpose, the execution of the task is at least a required condition for the execution of a subsequent task. The Petri net of the first aspect comprises one or more input places that contain information about the conditions required to execute the task, wherein the one or more input places are connected to the transition of the Petri net by in each case one or more input edges. Furthermore, the method comprises initializing the Petri net by an initial marking, by setting corresponding conditions for executing at least one or more tasks from the number of tasks of the software as fulfilled. In addition, the method comprises propagating along the Petri net starting from the initial marking by determining tasks of the software for which the required conditions are fulfilled at each relevant propagation step. Finally, the method comprises generating a reachability graph that comprises a number of nodes, wherein each node comprises information about fulfilled required conditions for executing tasks at the relevant propagation step along the Petri net and reflects an operating state of the sensor system. The information contained in the node contains a marking of the Petri net for the relevant propagation step, wherein the information contained in the first and last node includes the initial marking of the Petri net.

A second general aspect of the present invention relates to a method for recognizing a malfunction of a sensor system using a reachability graph. According to an example embodiment of the present invention, the method comprises receiving a reachability graph for recognizing a malfunction of a sensor system generated according to the first aspect. Furthermore, the method comprises processing a validation data set through the received reachability graph.

A third general aspect of the present invention relates to a module that is designed to execute the method for generating a reachability graph for recognizing a malfunction of a sensor system according to the first general aspect of the present invention.

A fourth general aspect of the present invention relates to a sensor system that is designed to generate a validation data set that is suitable to be processed in the method according to the second aspect of the present invention.

A fifth general aspect of the present invention relates to a module that is designed to receive a reachability graph from a module according to the third aspect of the present invention. Moreover, the module of the fifth aspect is designed to receive a validation data set from a sensor system according to the fourth aspect and to execute the method for recognizing a malfunction of a sensor system according to the second aspect of the present invention.

A sixth general aspect of the present invention also relates to a computer program that is designed to execute the method of the present invention.

The techniques of the first to sixth general aspects of the present invention can have one or more of the following advantages.

First, compared with some techniques of the related art, the techniques of the present invention provide the ability to estimate which operating states of a sensor system can be achieved (for example, all possible operating states including those that can occur if the sensor system is placed into service in a new environment). In particular, this knowledge can be acquired with the aid of software that operates the sensor system without the sensor system having to be put into operation.

Second, based on knowledge of operating states of a sensor system, the present techniques of the present invention can enable recognition of a malfunction of the sensor system (or, in other words, a risk that a malfunction of the sensor system can occur), for example, if the sensor system is operated in a new environment.

Third, in the present techniques of the present invention, the knowledge of the operating states can be implemented directly into the sensor system, such that it can efficiently figure out in real time (for example, if the detected image data are processed in real time by the sensor system) if a malfunction of the sensor system may occur. In particular, the present techniques provide the ability to prevent a function of the apparatus that is allocated to the sensor system from being impaired by the sensor system if the sensor system has the malfunction.

Some terms are used in the present disclosure in the following way:

The term “sensor system” refers to any system that can contain one or more sensors such as cameras, radar sensors, lidar sensors, ultrasonic sensors or heat sensors as modules. CPU cores, system-on-a-chip (SoC) hardware, RAM, hard disks, processing modules (for example, image processing modules), and communication interfaces to other apparatuses can be mentioned as a non-exhaustive list of further modules of the sensor system. The above-mentioned sensors can detect their environment and generate them, for example, in the form of image data or data series. A sensor system can be used, for example, within the framework of semi-autonomous, autonomous or assisted driving of a vehicle in order to provide a functionality for the vehicle (for example, in relation to safety functions, the realization of driver information and comfort functions, such as intelligent headlight control and traffic sign information). In other examples, it is possible that the sensor system can be used for a monitoring task (for example, example of a production process and/or for quality assurance) (for example, for monitoring the environment of an at least semi-autonomous robot).

A sensor system can comprise a camera (for example, front and/or rear camera of a vehicle) and a system-on-chip (SoC), which contains, for example, a microprocessor for image processing algorithms. A camera-based sensor system can use one or more technical paths for image processing. The first path of such a sensor system can use programmed algorithms to recognize the typical appearance of object classes such as vehicles, cyclists or road markings. In the second path, the camera-based sensor system can use the optical flow and the so-called Structure from Motion (SfM) to recognize raised objects bordering the road, such as curbs, crash barriers or guardrails. Corresponding image points can be tracked in their movement. From this, a three-dimensional structure can be estimated from the two-dimensional camera image. The third path can be based on artificial intelligence (for example, based on a computer-based machine learning system) by classifying objects such as vehicles parked at the side of the road and distinguishing road surfaces from the edge of the road.

The exemplary sensor system of a vehicle described above can communicate via corresponding interfaces with other systems in the vehicle, such as a vehicle computer or electronic control unit (ECU), as well as with systems external to the vehicle, such as cloud systems.

In the following, the term “software” refers to software that can operate a sensor system. This means that this software can manage various system resources of a sensor system, such as CPU cores, main memory, hard disks, processing modules (for example, image processing module), input and output devices, and make them available for application programs of the sensor system and/or for various tasks (for example, in connection with image processing). For example, the software can be an operating system (or “OS” for short) of the sensor system.

Accordingly, the term “software task” refers to a schedulable unit and is managed before the software (for example, by the operating system). A task can be a part of the code or a function that executes a certain activity if it is authorized for execution. A task of the software in connection with the image processing of a camera can be a call-up of one of the following tasks in the sensor system, such as “Reading in of a new image,” “Image preprocessing,” “Execution of a neural network” (for example, a convolutional neural network or “CNN” for short) for, for example, classification or regression tasks (for example, for object recognition such as pedestrians, traffic signs, etc.), “Calculation of optical flow,” “3D road surface estimation,” “Road marking detection” or others. The software can decide when which task can run on the CPU cores of the sensor system. An application program of the sensor system can also run in the context of a task. The software's “task scheduler” can control the execution of tasks according to the task priority and the task scheduling policy. In some cases, the “task scheduler” can be part of the software (for example, an operating system).

Within the scope of the present invention, a task may require the completion of the execution of one or more other tasks in order to begin its execution. In some cases, “software events” can be generated by the software if these required tasks have completed their execution (for example, one “software event” per completed task). Alternatively or additionally, other “software events” can be generated that are required for the execution of the task and are not related to the previously completed tasks. In this sense, the task can be executed (or continue its execution) if one or more certain software events occur (more on “required conditions” in the following paragraphs). Other processes that run in conjunction with the software and may be required to execute the tasks include interrupts, locks, software spin-locks or any combination thereof.

In the present invention, a “Petri net” represents a model that models various processes in software (for example, in an operating system) that operates a sensor system (for example, a camera). As mentioned above, the processes can comprise a non-exhaustive list of tasks of the software, software events, interrupts, locks, or software spin-locks. A Petri net can be described as a special type of directed graph that is constructed from three types of objects. These objects are places (input or output places), transitions and directed edges (hereinafter also referred to as “edges” for short), which connect places to transitions and transitions to places; see for example doi.org/10.1109/41.334574 for further details. Pictorially, places can be represented by circles 14a-f, transitions by boxes 12a-d, and directed edges by arrows 16a-f; see FIGS. 2A to 2E and the discussions below. A place is an input place for a transition if there is a directed edge that connects this place to the transition (more precisely: a directed edge 16a goes in the direction from a place 14a to a transition 12a). A place is a output place of a transition if there is a directed edge that connects the transition to this place (more precisely: a directed edge 16c goes in the direction from a transition 12a to a place 14c).

A “transition” as used in the present disclosure can describe a task of the software, and an “input place” associated to this transition by an “input edge” can describe a “required condition” for executing the task linked to this transition. In some cases, a transition can only be linked to a single input place. In other cases, a transition can be associated with more than one input place (for example, two or more, with three or more input places), which describe the respective required conditions. A non-exhaustive list of “required conditions” comprises the occurrence of any combination of one or more events of the software, one or more interrupts of the software, one or more locks of the software, or one or more spin-locks of the software that are required to execute a task under consideration (in other words, each of the required conditions must contribute appropriately to the execution of the task). In some cases, the execution of another (previously executed) task of the software assigned to another transition of the Petri net can be one of the required conditions for the task to be executed subsequently. The presence of the required condition (in other words, if this condition is fulfilled) is indicated by a token in the input place (i.e., the input place is filled with the token); see bold dots 18a-d in FIGS. 2A to 2E The input place can be filled with no token (if no required condition allocated to this place is fulfilled), with one token, with two tokens, with three tokens or more. As explained in more detail below, it is not necessary to execute the actual tasks of the software (for example, tasks that require image processing) to generate the Petri net and propagate along this net; rather, it is a matter of determining the conditions required to execute this task when propagating along the Petri net.

A “transition” of the Petri net can be switched (in other words, is considered activated/is switchable) if each input place of this transition contains at least the number of tokens corresponding to the weight of the input edge connected to the transition. Switching the activated transition can signify that the task assigned to it is executed. In addition, switching an activated transition can remove from each input place the number of tokens corresponding to the weight of the input edge connecting this input place to the transition. It can also store the number of tokens in each output place that corresponds to the weight of the output edge that connects this transition to the output place. At each propagation step (in other words, at a corresponding time), a distribution of tokens on the places, the so-called Petri net marking, can define an “operating state of the sensor system” (more on this below). The initial marking corresponds to the initial distribution of tokens to the places of the Petri net: starting from the initial distribution and assuming that one or more transitions are switchable in the sense defined above, propagation along the Petri net can be carried out step-by-step. This means that such a propagation can be regarded as a switching sequence of transitions and a discrete movement of tokens within the Petri net (a distribution of tokens per propagation step).

The term “reachability graph” refers to a graph that comprises nodes that contain information about the Petri net markings during the (step-by-step) propagation along the Petri net (a node can describe exactly one Petri net marking for a propagation step). In one case, a set of nodes can appear in a certain order during (step-by-step) propagation along the Petri net, because in another case a different set of nodes can appear (in both cases, the first node can describe the initial marking). Each of these orders determines a corresponding step-by-step propagation through the Petri net, and such an order is referred to below as the “path of the reachability graph.” The “reachability graph” can comprise all possible paths (see below for further explanations of the reachability graph).

In the present disclosure, the term “validation data set” refers to a collection of a plurality of image data or data series that can be used for recognizing a malfunction of a sensor system, as explained in more detail below. The validation data set can comprise a sequence of images, video data, data series (for example, time series) or any combination thereof. In some cases, the validation data set can also comprise metadata (for example, a time stamp or other metadata) that characterizes the sequence of data enumerated above. The image data or data series can be generated by means of various sensors of the sensor system (for example, as already mentioned above, cameras, radar, lidar, ultrasonic or heat sensors). The image data or data series can be processed in real time for the purpose of recognizing the malfunction of the sensor system, for example during video recording by a camera of the sensor system or during measurements by a heat sensor (for example, when the vehicle is moving). In some cases, the detected data can first be detected by sensors and then processed by the sensor system comprising these sensors in the above-mentioned sense. In addition, this data can be generated by an external apparatus (for example, by another sensor system that can be operated by the same software) and/or synthetic image data can be generated, which is then used on the sensor system to recognize the malfunction of the sensor system; more on this below.

The term “a malfunction” of a sensor system means any disruption of that system, including any disruption that can impair the ability to execute one or more functions of an apparatus that uses information from the sensor system to ensue these functions. For example, if the sensor system is used in a vehicle, the term “function” can comprise control-based functions of a vehicle, such as functions of driving or parking assistance systems, functions for autonomous or semi-autonomous driving, or functions in conjunction with climate control systems and/or electronic systems for controlling functions of the interior (or any combination of the aforementioned functions). The term “a malfunction” will also comprise “a potential malfunction,” i.e. a malfunction that has not yet taken place but may nevertheless occur (the prerequisites for this are explained below).

Accordingly, operating states of modules of the sensor system as a whole can define the “operating state of the sensor system.” The tasks of the software, which for example provide/control call-ups to one or more modules, so that they execute corresponding tasks, can change the operating states of these modules and consequently the operating state of the sensor system. As explained in more detail below, such a change in the operating state of the sensor system can in some cases lead to “an operating fault.” It can be said that “the Petri net” (or a “reachability graph”) reflects the “operating states of the sensor system,” since this net can contain information about the tasks of the software; more on this below.

The term “vehicle” comprises any apparatus designed for the transportation of passengers and/or cargo. The vehicle can be a motor vehicle (for example, an at least partially autonomously operating/assisted motor vehicle, in particular a car or a truck). However, the vehicle can also be a ship, a train, an aircraft or a spacecraft.

### BRIEF DESCRIPTION OF THE DRAWINGS

FIG. 1A is a flow chart that represents an example of a method for generating a reachability graph for recognizing a malfunction of a sensor system according to the first aspect of the present invention.

FIG. 1B is a flow chart that shows an example of a method for recognizing a malfunction of a sensor system using a reachability graph according to the second aspect of the present invention.

FIGS. 2A to 2E schematically show an exemplary structure of a Petri net 10, which has four transitions (boxes 12a-d), six places (circles 14a-f), and twelve edges (arrows 16a-f). The exemplary distributions of tokens at the places during propagation along the Petri net (bold dots 18a-d) are also shown in these figures.

FIG. 3 schematically shows an exemplary structure of a reachability graph 50, which represents a certain order of five markings during propagation along the Petri net in five steps that are shown in FIGS. 2E to 2E. These markings are shown as “nodes” 52a, b, c and e of the reachability graph and their order (a “path”) is represented by solid arrows. A possible, but in this example not realized, marking with the relevant part of the path, which also belong to the reachability graph, are illustrated by dashed arrows and a dashed box 52d.

FIG. 4 schematically shows an exemplary number of reached nodes 62, 70 of the reachability graph depending on time 61 for a validation data set (time span 71) and an augmented validation data set (time spans 71 and 72).

### DETAILED DESCRIPTION OF EXAMPLE EMBODIMENTS

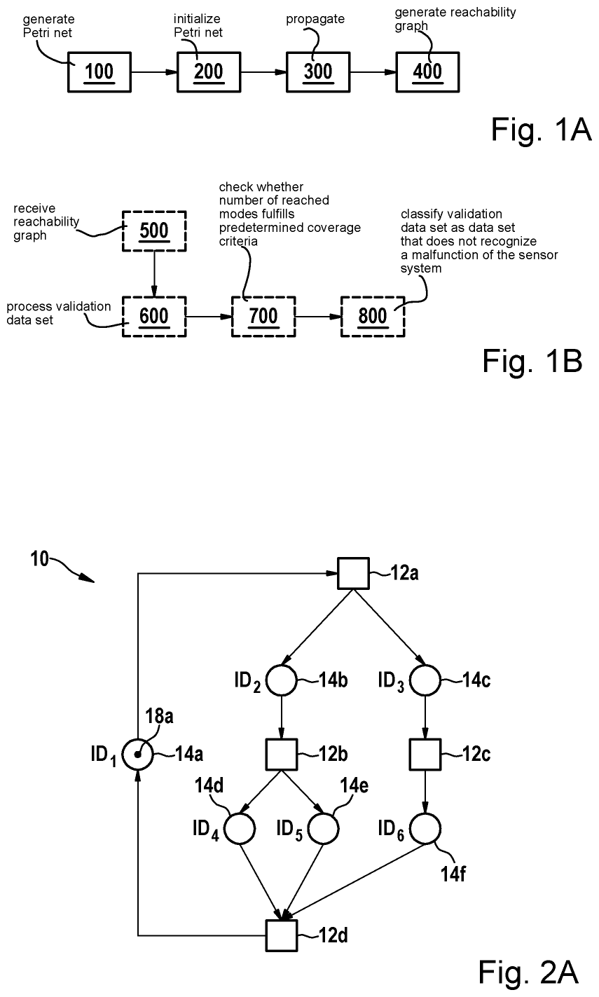

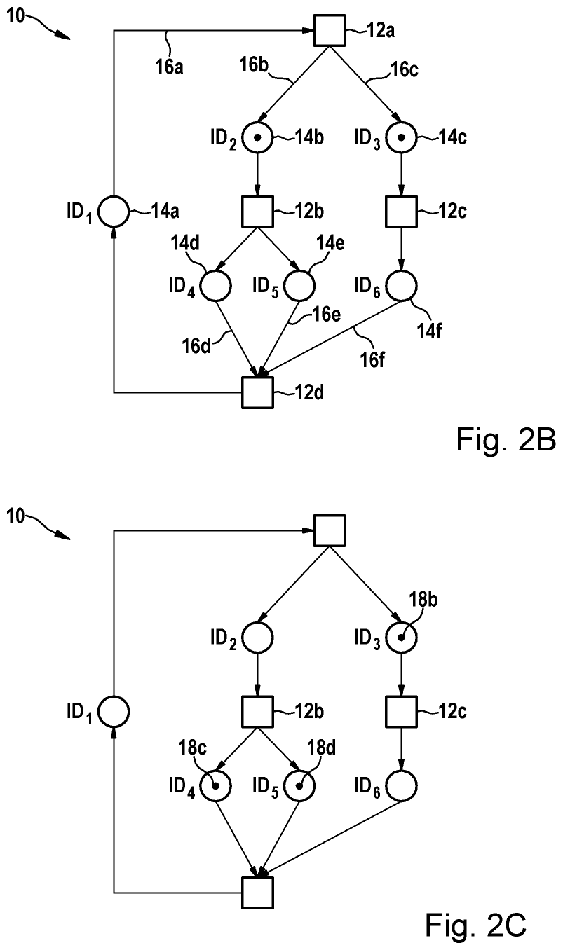

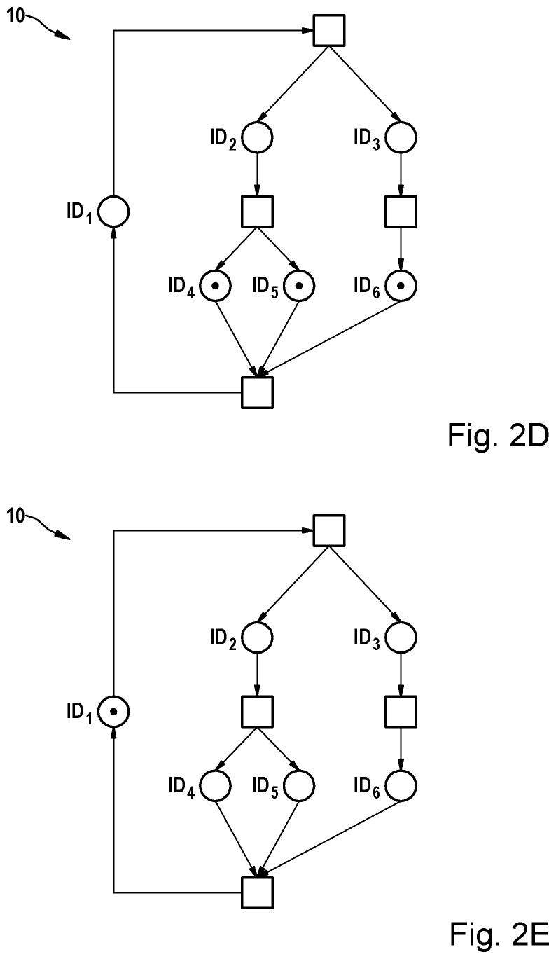

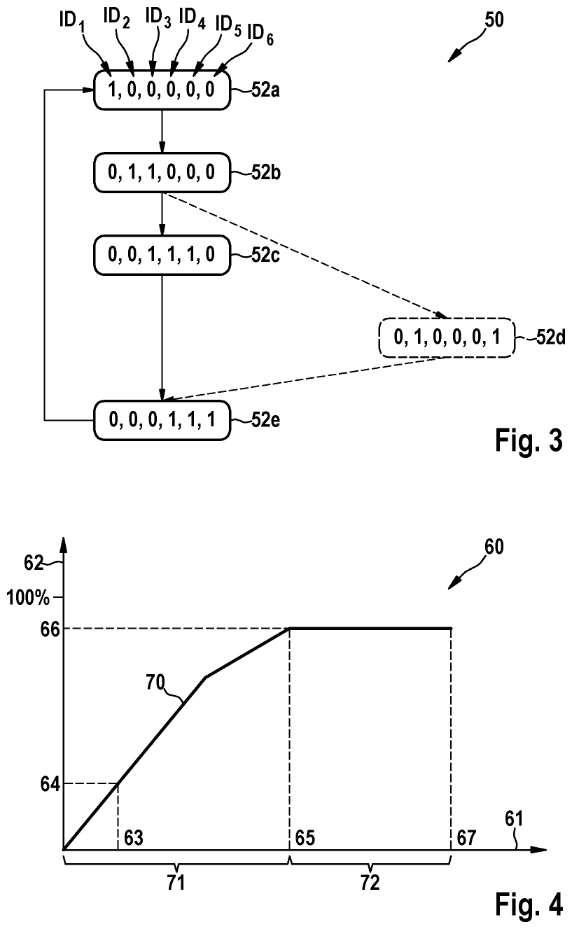

Initially, with reference to FIG. 1A, techniques for generating a reachability graph for recognizing a malfunction in a sensor system are described. An exemplary structure of a Petri net and the propagation along it is then discussed with reference to FIGS. 2A to 2E. Next, an example of the structure of a reachability graph is presented in conjunction with FIG. 3. The techniques for recognizing a malfunction of a sensor system using a reachability graph are discussed with reference to FIG. 1B and FIG. 4.

As outlined in FIG. 1A, a first general aspect relates to a method (for example, a computer-implemented method) for generating a reachability graph 50 for recognizing a malfunction of a sensor system. The malfunction of the sensor system (for example, as mentioned above in relation to an operating state of the sensor system) can be, for example, an overload of the sensor system (for example, an overload of the CPU cores or a lack of memory capacity), a delayed communication within a module or between different modules of the sensor system (for example, between a sensor of the sensor system and its memory or its SoC hardware) or between the sensor system and a module external to the sensor system (for example, a vehicle computer), a crash of one or more application programs of the sensor system (for example, in relation to image processing algorithms), or any other malfunction in the sense defined above. In some cases, the malfunction of the sensor system can occur because the image data (for example, video data) being processed by the sensor system (for example, in real time during image capture) contains features that result in one or more of the aforementioned malfunctions of the sensor system during this image processing. In the example of a vehicle-integrated sensor system, features on the images are possible in connection with street scenes recorded on them with one or more objects such as traffic signs, lanes or other road or pedestrian zone markings, trees, buildings, road users such as pedestrians, cyclists or other vehicles. In some cases, image processing of one or more of the above-mentioned features, for example, image classification such as semantic segmentation of an image (for example, region-by-region and/or pixel-by-pixel classification of the features of the image) by a neural network can cause one or more of the above-listed malfunctions.

In the present disclosure, the sensor system (which comprises, for example, one or more sensors such as cameras, radar, lidar, ultrasonic or thermal sensors) is operable with software that is designed to execute a number of tasks (for example, in relation to image processing, as already described above) in a certain order.

The first step of the method comprises generating 100 a Petri net 10 that contains information about the number of tasks of the software of the sensor system and their order. For example, the number of tasks can be five or more, ten or more, fifty or more, one hundred or more. The Petri net can comprise a number of transitions 12a-d, a number of places 14a-f, and a number of edges 16a-f, as shown by way of example in FIGS. 2A to 2E. Each task of the present techniques is described by a relevant transition 12a-d of the Petri net, which is executed by the software, if one or more required conditions for that task are fulfilled (the term “required conditions” is already introduced above). The example in FIG. 2A shows a Petri net 10 with four transitions, which are shown as boxes 12a-d in this figure. As already described above, each transition can be assigned to a certain task: for example, transition 12a can be assigned to the task “Reading in of a new image,” transition 12b to the task “Calculation of the optical flow” and transition 12c to the task “Execution of the CNN.”

In addition, in the present disclosure, executing the task is at least one required condition for executing a subsequent task. Back to the example in FIG. 2A: the tasks 12b and 12c can only be started once task 12a has been (fully) executed, and the task 12d can only be started once both tasks 12b and 12c have been executed.

In the techniques of the present disclosure, the Petri net comprises one or more input places 14a-f, which contain information about the conditions required to execute the task, for example, to execute the task “Reading in of a new image,” which may be linked to the transition 12a, the task “Calculation of optical flow,” which may be linked to the transition 12b, or another task. The one or more input places are in each case connected to the transition of the Petri net by one or more input edges 16a-f. In addition, an edge can connect exactly one place to one transition or one transition to one place, wherein each transition can be connected to one or more input places of the number of places by in each case one or more input edges of the number of edges. In the example of FIGS. 2A and 2B, the transition 12a is connected to a single input place 14a by the input edge 16a, while the transition 12d is connected to three input places 14d, e, f by the corresponding three input edges 16d, e, f. In some cases, one or more transitions can be connected to one or more output places of the number of places by in each case one or more output edges of the number of edges (see also definitions above). In addition, a place can be an output place for a transition, while the same place is an input place for another transition. Back to the example in FIGS. 2a and 2b: three places 14d, e, f are the input places for the transition 12d, while two of them 14d, e are the output places for the transition 12b and one of them 14f is the output place for the transition 12c.

The next step of the method comprises initializing 200 the Petri net by an initial marking, by setting corresponding conditions for executing at least one or more tasks from the number of tasks of the software as fulfilled. It is possible that the required conditions for the remaining tasks from the number of tasks are not (fully or partially) fulfilled and these tasks can therefore not be executed (at least in the propagation step if the task for which the required conditions are fulfilled is executed, more on this below). Each input place of the one or more input places of the transition describing the task can be filled with a token 18a-d, if a required condition assigned to this input place is fulfilled. In FIG. 2A, the initialized Petri net 10 is shown as an example with a token that fills the input place 14a with a token. The required conditions for the remaining tasks 12b-d are not fulfilled in this example, and therefore the corresponding input places 14b-f for the transitions 12b, c, d, to which these remaining tasks are assigned, are not filled with any token. This is the initial marking of the Petri net in the example in FIG. 2A. This initial marking can simulate the situation in which an image has arrived at a corresponding module of the sensor system, for example, and the required condition for executing the task “Reading in of a new image” has thus been fulfilled. (As explained above, actual execution is not necessary for the purpose of generating a reachability graph.) In another example (not shown in the figures), a different initial marking can be selected with which, for example, three input places 14d, e, f for the transition 12d are in each case filled with a token, which would mean that the three required conditions for the task linked to the transition 12d are fulfilled.

In the techniques of the present disclosure, initializing the Petri net can comprise filling each of the input places for one or more transitions that describe the at least one or more tasks with a required number of tokens that provide the fulfillment of the required conditions for executing these tasks. For example, if the task “Reading in of two consecutive images” is allocated to transition 12a, this task can only be executed if the input place 14a of this transition is filled with two tokens (in each case per image), which means that the required condition for the task “Reading in of two consecutive images” is fulfilled. In a non-limiting example, if the sensor system comprises a camera, the initial marking of the Petri net can be created with the aid of the “task scheduler” of the software, which can for example realize the filling of places with the desired number of token by specifying respective delays for the execution of the tasks (for example, a task scheduler table can be created by the task scheduler).

Furthermore, the present techniques comprise propagating 300 along the Petri net starting from the initial marking by determining tasks of the software for which the required conditions are fulfilled at each relevant propagation step. In some cases, in each case one or more input edges can control the switching of the transition, if all the required conditions for executing this task are fulfilled. (This “fulfillment” is achieved by filling the input places with tokens, as already discussed above.) In addition, each of the in each case one or more input edges of the transition can be described by a weight. The transition can be switchable if a number of tokens in each of the one or more input places of the transition is at least equal to the weight of the relevant input edge of the one or more input edges that connects this input place to the transition.

This procedure can be illustrated in more detail in the example in FIGS. 2A to 2E. As already explained above, the exemplary initial marking of FIG. 2A can enable the execution of the task that is allocated to the transition 12a in the first propagation step. In this non-limiting case, the input edge 16a of this transition can be described by the weight “one” and control the switching of the transition 12a, since the input place 14a contains the “one” token. In another case, for example, if the weight of the input edge 16a is equal to “two,” the transition 12a with a single token 18a in the input place 14a cannot lead to the switching of this transition 12a: In this situation, the initial marking may not be suitable because further propagation along the Petri net is blocked (i.e., it leads to a “deadlock”). To avoid this problem, the input place 14a, for example, can be occupied with two tokens. Alternatively, the filling of the transition 12a with the one token 18a can be left at the input place 14a, but in addition at least one of the subsequent places 14b, c can be occupied with a token. In this way, the propagation can be continued along the Petri net and, upon the second run, the place 14a can be filled with the second (missing) token (see also further discussions). This situation can occur in one of the examples above, in which transition 12a is assigned with the task “Reading in of two consecutive images.” The weight of an input place can have the values one, two, three, four, five or more.

In the techniques of the present disclosure, each of the in each case one or more output edges of the transition can be described by a weight. In addition, after switching the transition, one or more tokens can be removed from the number of tokens of the input place of this transition, the number of which is equal to the weight of the corresponding input edge of the transition. In addition, one or more tokens can be added in the relevant output place of the transition, the number of which is equal to the weight of the corresponding output edge of the transition.

Back to the example in FIGS. 2A to 2E: the token 18a can be removed from the input place 14a (the weight of which is “one” as an example) after the transition 12a has been switched (in other words, execution of the task linked to the transition 12a is enabled). In a non-limiting case, the weights of the two output edges 16b, 16c of the transition 12a are equal to “one.” Therefore, a token can be added to each of the output places 14b, 14c, as can be seen by two bold dots in these places in FIG. 2B. This distribution of tokens to the laces (two tokens at places 14b, 14c and none at the remaining places 14a, d, e, f) represents the Petri net marking for the second propagation step. Now, the transitions 12b and 12c can be switchable if, for example, their input edges (one input edge per transition 12b, 12c in the example of FIG. 2B) have the weight “one” (i.e., “all required conditions” for the tasks assigned to these transitions in the sense described above are fulfilled). In one example, the transition 12b can be switched first, wherein the token is removed from the input place 14b of the transition 12b and added to each of the two output places 14d, e of this transition, provided that the weight of the output edges of this transition is, for example, equal to “one” (see FIG. 2C).

In the next propagation step, only the transition 12c can be switched for the marking shown in FIG. 2C, because one 14f of the three input places 14d, e, f is not occupied by any token. The next propagation step after switching the transition 12c is shown in FIG. 2D. (In this non-limiting example, the output edge of transition 12c has a weight equal to “one.”) It should be observed that in another example, the transitions 12b, c can run in reverse order, i.e. first the transition 12c and then the transition 12b (not shown in the figures). Now, the last propagation step in the first loop can be completed by the Petri net (three input places 14d, e, f are in each case filled with a token), because the three input edges 16d, e, f of the transition 12d have a weight equal to “one” in this example. Finally, the token can be removed from these places and a token can be added at the output place 18a of transition 12d (the weight of the output edge of transition 12d is equal to “one” in this example). The end marking of the Petri net after the first propagation loop corresponds to its initial marking, as shown in FIG. 2E (cf. FIG. 2A).

In this way, the second (or any subsequent) propagation loop can also be executed along the Petri net (for example, the transitions 12b, c described above can run in reverse order in the second propagation loop). It should be noted that in another example, the input edge of the transition 12c can have the weight “two” (not shown in the figures). In this case, the transition 12c cannot be switched at all during the first propagation loop, because the input place 14c can only be filled with one token in the first propagation loop: the switching of this transition 12c can, for example, only take place in the second propagation loop along the Petri net (in other words: during the second run of the Petri net) provided that the input place 14c is occupied with the second token. Similarly as described in connection with transition 12a (in the example with which the task “Reading in of two consecutive images” was assigned to transition 12a), in this case the initial marking for the Petri net can comprise a token at place 14f (the output place of transition 12c), in order to ensure propagation along the Petri net to the end, without switching the transition 12c within the first propagation loop. Such a scenario can occur, for example, if the transition 12c is allocated the task “Calculation of the optical flow for at least two images,” for the calculation of which two consecutive images may be required, such that this task cannot start after the reception of the first image.

The next step of the method comprises generating 400 a reachability graph that comprises a number of nodes 52a-e, wherein each node comprises information about fulfilled required conditions for executing tasks at the relevant propagation step along the Petri net and reflects an operating state of the sensor system (see also definitions above). In the present techniques, the information contained in the node includes a marking of the Petri net for the relevant propagation step (for example, for the propagation steps described in FIGS. 2A to 2E above). In addition, the information included in the first and last node contains the initial marking of the Petri net (see, for example, FIG. 2A and FIG. 2E). In addition, a node of the reachability graph can be specified by a number of identifiers, ID₁-ID₆, wherein identifier is allocated to an input place or output place of a corresponding transition and describes a number of tokens in this input place or output place (as explained above, an input place for one transition can in some cases be considered an output place for another transition). As explained in detail above, the number of tokens can change during propagation along the Petri net (see an example in conjunction with FIGS. 2A to 2E).

The method step described above in relation to generating the reachability graph can be illustrated with the aid of FIG. 3, which shows nodes with five markings during the exemplary propagation along the Petri net in five steps according to FIGS. 2A to 2E (the fact that the first and fifth nodes contain the initial marking is shown by an arrow connecting the fourth and fifth nodes to one another). The identifiers introduced above, ID₁-ID⁶, are shown in FIGS. 2A to 2E and FIG. 3. For example, the first node 52a is given by a number of indicators (1, 0, 0, 0, 0, 0) (one token at the place 18a and no token at the remaining places, see FIG. 2A), while the third node 52c is given by a number of indicators (0, 0, 1, 1, 1, 0) (one token at the three places 18b, c, d and no token at the remaining places, see FIG. 2C).

As described above, an operating state of the sensor system prior to executing one task of the number of tasks can differ from another operating state of the sensor system after executing the task. It can be said that the nodes reflect the operating state of the sensor system since, for example, a node 52b contains a marking (0, 1, 1, 0, 0, 0) of the Petri net to a propagation step prior to executing the respective tasks 12b, wherein the subsequent node 52c includes another marking (0, 0, 1, 1, 1, 0) of the Petri net to the next propagation step after the already executed tasks 12b.

In the techniques of the present disclosure, the reachability graph can comprise a number of paths, wherein each path contains a set of nodes of the number of nodes that appear in a certain order during propagation along the Petri net. In some cases, a part of a path can overlap with a part of another path. Such a path of the reachability graph is shown by solid boxes (“nodes”) and solid arrows that connect these boxes (“order”) as an example in FIG. 3. This path exactly describes the propagation during the first pass along the Petri net, which was discussed in detail in connection with FIGS. 2A to 2E. The node (0, 1, 0, 0, 0, 1) does not occur in this certain order, because it corresponds to the reverse switching sequence of the transitions 12b, c, specifically if the transition 12c is switched first and then the transition 12b is switched (compare with the switching sequence in FIGS. 2B to 2D). Therefore, for this exemplary Petri net 10, there may be a second path that belongs to the reachability graph and that contains a node (0, 1, 0, 0, 0, 1) instead of a node (0, 0, 1, 1, 1, 0) in its node set (see dashed box 52d in FIG. 3). The first and second paths partially overlap, and the non-overlapping part of the two paths is shown by dashed arrows in the exemplary FIG. 3. As already discussed above, the second path of the reachability graph can occur in the second (or another further) pass of the Petri net.

In the present techniques, the reachability graph can comprise five or more, ten or more, twenty or more, thirty or more, fifty or more, one hundred or more nodes. In some cases, one or more, two or more, three or more, five or more, ten or more, fifty or more, one hundred or more passes (in other words, propagation loops) can be executed along the Petri net to generate the reachability graph.

In the techniques of the present disclosure, in some cases, a number of reachability graphs (two or more, three or more, ten or more) can be generated in the same manner using corresponding initial markings (for example, one reachability graph per one initial marking).

A second general aspect of the present disclosure relates to a method (for example, a computer-implemented method) for recognizing a malfunction of a sensor system using a reachability graph. The method comprises receiving 500 a reachability graph for recognizing a malfunction of a sensor system generated according to the first aspect. Furthermore, the method comprises processing 600 a validation data set through the received reachability graph (the definition for validation data sets is already specified above).

In the techniques of the present disclosure, processing 600 of the validation data set by the received reachability graph can comprise identifying a number of reached nodes in the reachability graph in relation to the validation data set that reflects a number of covered operating states of the sensor system (in the sense discussed above). For this purpose, the method step “processing” can comprise identifying a number of reached paths in the reachability graph in relation to the validation data set.

Back to the non-limiting example of a sensor system that comprises a camera (for example, a vehicle-integrated camera such as a Generation 3 multifunction camera or MPC3 camera for short): software that operates this sensor system can, for example, collect information during video recording by the camera (for example, when the vehicle is moving) that can be useful for identifying nodes that have been reached. In practice, this can be done, for example, by sending a signal at the end of each of the tasks executed (for example, in connection with image processing) in the sensor system. This signal can, for example, contain information (for example, an ID) in a Universal Asynchronous Receiver/Transmitter (UART) debugging interface of the sensor system that uniquely identifies the task (for example, the task “Reading in of a new image,” task “Execution of the CNN” or another task). This information can then be used in order to identify the corresponding switching sequences in the Petri net, the nodes in the reachability graph, the paths in the reachability graph or any combination of these. In some cases, this information can form part of the validation data set.

In the present techniques, it can be checked 700 whether the number of reached nodes fulfills a predetermined coverage criterion. Furthermore, the method can comprise classifying 800 the validation data set as a data set that does not recognize a malfunction of a sensor system (in other words, that the malfunction can potentially occur) if the number of reached nodes fulfills a predetermined coverage criterion. Otherwise, if the number of reached nodes does not fulfill the predetermined coverage criterion, the method can comprise classifying the validation data set as a data set that recognizes a malfunction of a sensor system (for example, the malfunction that can potentially occur). In one example, the predetermined coverage criterion can comprise that the number of reached nodes falls below a predefined threshold value (for example, if the number of reached nodes of all nodes contained in the reachability graph falls below 90% or less, 80% or less, or 50% or less).

This scenario can be seen in the example in FIG. 4, which schematically shows an exemplary number of reached nodes 62, 70 of the reachability graph depending on the time 61 for a validation data set (time span 71). In this case, time can mean a number of validation hours, for example in the form of the consumed playback of video data that the validation data set comprises. In the non-limiting example of FIG. 4, the number of reached nodes at time 63 (for example 100 hours) corresponds to the value 64 (for example, 30%), which falls below the predefined threshold value (which is, for example, 90%). In this case, the validation data set (more precisely, its part that has been processed up to time 63) can be classified as a data set that does not recognize a malfunction of the sensor system (for example, a malfunction that can potentially occur). In other words, this validation data set does not contain enough data in the sense that the resulting coverage of the reachability graphs is too low (i.e., the number of reached nodes is below the threshold value). In this situation, one or more paths of the reachability graphs that were not ascertained during the processing of the validation data set (but which are in the reachability graph) can lead to a malfunction of the sensor system (see above discussions on this). On the other hand, in the same FIG. 3, the number of reached nodes at time 65 (for example 1000 hours) corresponds to the value 65 (for example, 92%), which exceeds the predefined threshold value (for example, 90%). Now, the validation data set (which has been processed up to time 65, i.e. for the entire time period 71) can be classified as a data set that recognizes a malfunction of the sensor system.

Furthermore, the method can comprise augmenting the validation data set by adding another validation data set. Back to the example of the sensor system in a vehicle (for example for use in driver assistance systems, semi-automated or automated driving): the validation data set can in some cases comprise video data detected by the sensor system of the moving vehicle in different countries. The exemplary number of reached nodes 62, 70 of the reachability graph as a function of time 61 for the validation data set (time span 71) has already been discussed in connection with FIG. 4. Now, video data for a new country can be collected in the same way, which can be understood as the “other validation data set.”

The next step of the method can comprise processing the augmented validation data set through the received reachability graph. In the present techniques, processing the augmented validation data set through the received reachability graph can comprise identifying a number of reached nodes in the reachability graph in relation to the augmented validation data set (for example, in the same manner as already discussed in conjunction with the validation data set). For this purpose, the method step “processing” can comprise identifying a number of reached paths in the reachability graph in relation to the augmented validation data set. An exemplary number of reached nodes 62, 70 of the reachability graph as a function of time 61 for the augmented validation data set (time spans 71 and 72) is shown schematically in FIG. 4. In addition to the curve for the validation data set, this curve 70 also contains a continuation for the time period 72 (which corresponds to the other added validation data set).

Furthermore, the present techniques can comprise comparing the number in relation to the validation data set and the number in relation to the augmented validation data set. For this purpose, for example, the numbers of reached nodes at the end of the respective time spans can be compared (time 65 at the end of time span 71 and time 67 at the end of time spans 71 and 72 in the example of FIG. 4). It can also be checked whether a comparison result fulfills a predetermined criterion. Furthermore, the method can comprise classifying the augmented validation data set as a data set that does not recognize an additional malfunction of a sensor system (for example, the malfunction that can be recognized using the validation data set) if the comparison result fulfills a predetermined criterion. Otherwise, if the comparison result does not fulfill the predetermined criterion, the method can comprise classifying the augmented validation data set as a data set that recognizes an additional malfunction of a sensor system (for example, in addition to the malfunction that can be recognized using the validation data set). In this situation, one or more paths of the reachability graphs that were not ascertained during the processing of the augmented validation data set (but which are contained in the reachability graph) can lead to a malfunction of the sensor system.

In some cases, the method step “comparing” can comprise calculating a ratio between the number in relation to the validation data set and the number in relation to the augmented validation data set, wherein the comparing result comprises the ratio. For example, the predetermined criterion can comprise that the ratio falls below a predefined threshold value (for example, 0.95 or less, 0.9 or less, or 0.8 or less). In a non-limiting example of FIG. 4, the numbers of reached nodes in the reachability graph in relation to the validation data set and the augmented validation data set are equal (their value is indicated by reference 66 in this figure). The ratio therefore has the value “one.” In this case, the augmented validation data set can be classified as a data set that does not recognize any additional malfunction of the sensor system (in other words, no additional malfunction that has already been analyzed based on the validation data set). This can be interpreted to mean that adding the other validation data set to the validation data set (for example, video data for the new country in the example above) did not result in any new reached nodes in the reachability graph in the example in FIG. 4: consequently, no malfunction of the sensor system is expected.

A third general aspect of the present disclosure relates to a module that is designed to execute the method for generating a reachability graph for recognizing a malfunction of a sensor system according to the first general aspect of the present disclosure. In one example, the module can be a module external to the sensor system, i.e. it is located outside the sensor system (for example, a module of a computing system). The software of the first aspect can be installed on this module, such that the reachability graph of the first aspect can be generated without, for example, the sensor system having to be put into operation.

A fourth general aspect of the present disclosure relates to a sensor system, which is designed to generate a validation data set (for example, as already described above for the example with a camera) that is suitable to be processed in the method according to the second aspect.

In one case, the sensor system can be designed to send the generated validation data set to a module (for example, a module external to the sensor system such as a module of a computing system or a data cloud system).

In another case, the sensor system of the fourth aspect can be designed to receive a reachability graph from a module according to the third aspect. (The sensor system can, for example, contain the reachability graph in compiled form.) For this purpose, the sensor system can be designed to process the generated validation data set through the reachability graph (for example, the validation data set can be generated and processed in real time if the sensor system is in operation). For this purpose, the sensor system can be designed to process the generated validation data set through the reachability graph in order to identify a number of reached paths in the reachability graph in relation to the validation data set. In addition, the sensor system can be designed to receive a known number of achieved paths according to the second aspect. For example, the known number of reached paths can be a number of reached paths in the reachability graph in relation to another validation data set (for example, the validation data set generated by the sensor system of the fourth aspect at an earlier time or by another sensor system).

For this purpose, the sensor system of the fourth aspect can be designed to check whether the known number of reached paths comprises each path of the number of reached paths. In addition, the sensor system can be designed to determine a number of unknown paths if at least one path of the number of reached paths is not contained in the known number of reached paths. In some cases, the sensor system can be further designed to send a number of unknown paths to a module (for example, a module external to the sensor system such as a module of a computing system or a data cloud system). Alternatively or additionally, the sensor system can be further designed to disable communication with an apparatus that uses the information from the sensor system, in order to provide one or more functions of the apparatus (for example, the functions described above if the sensor system is used in a vehicle), if the number of unknown paths exceeds a predefined threshold value (for example, one or more, two or more, five or more, ten or more, fifty or more unknown paths).

A fifth general aspect of the present disclosure relates to a module that is designed to receive a reachability graph from a module according to the third aspect. (The module of the fifth aspect can, for example, contain the reachability graph in compiled form.) In addition, the module is designed to receive a validation data set from a sensor system according to the fourth aspect and to execute the method for recognizing a malfunction of the sensor system using the reachability graph according to the second aspect. In one example, the module can be a module external to the sensor system, i.e. it is located outside the sensor system (for example, a module of a computing system). In one case, the module of the third aspect and the module of the fifth aspect can be the modules of a stand-alone system. In another case, the module of the third aspect can be the modules of a distributed system. In the latter case, these modules can communicate via a network (for example, the Internet), for example.

A sixth general aspect of the present disclosure also relates to a computer program that is designed to execute the method of the present disclosure. The present disclosure also relates to a computer-readable medium (for example, a machine-readable storage medium such as an optical storage medium or read-only memory, for example, FLASH memory) and signals that store or encode the computer program of the present disclosure.

1-15. (canceled)

16. A method for generating a reachability graph for recognizing a malfunction of a sensor system, wherein the sensor system can be operated with software that is configured to execute a number of tasks in a specified order, the method comprising the following steps:
generating a Petri net, which contains information about the number of tasks of the sensor system software and their order, wherein each task of the number of tasks is described by a respective transition of the Petri net, which is executed by the software when one or more required conditions for the task are fulfilled, and wherein the execution of the task is at least one required condition for the execution of a subsequent task, and wherein the Petri net includes one or more input places, which contain information about the required conditions to execute the task, wherein the one or more input places are connected to the transition of the Petri net by in each case one or more input edges;
initializing the Petri net by an initial marking, by corresponding required conditions for executing at least one or more tasks from the number of tasks of the software being set as fulfilled;
propagating along the Petri net starting from the initial marking by determining those tasks of the software for which the required conditions are fulfilled at each relevant propagation step; and
generating a reachability graph that includes a number of nodes, wherein each node of the nodes includes information about fulfilled required conditions for executing tasks at a relevant propagation step along the Petri net and reflects an operating state of the sensor system, wherein the information contained in the node includes a marking of the Petri net for the relevant propagation step, and wherein the information contained in the first and last node includes the initial marking of the Petri net.

17. The method according to claim 16, wherein the Petri net includes a number of transitions, a number of places, and a number of edges, wherein:
each edge connects exactly one place to one transition or one transition to one place,
each transition is connected to one or more input places of the number of places by in each case one or more input edges of the number of edges,
each input place of the one or more input places of the transition describing the task is filled with a token, when a required condition assigned to the input place is fulfilled,
in each case one or more input edges control switching of the transition when all necessary conditions for performing the task are fulfilled, and
one or more of the transitions are connected to one or more output places of the number of places by in each case one or more output edges of the number of edges.

18. The method according to claim 17, wherein each place is an output place for a transition, while the same place is an input place for another transition.

19. The method according to claim 17, wherein the initializing of the Petri net includes filling each of the input places for one or more transitions that describe the at least one or more tasks with a required number of tokens that provide the fulfillment of the required conditions for executing the at least one or more tasks.

20. The method according to claim 19, wherein each of the one or more input edges of each transition is described by a weight, wherein the transition is switchable when a number of tokens in each of the one or more input places of the transition is at least equal to the weight of the input edge of the one or more input edges that connects the input place to the transition.

21. The method according to claim 20, wherein each of the one or more output edges of each transition is described by a weight, and wherein after switching the transition, one or more tokens are removed from the number of tokens of the input place of the transition, the number of which is equal to the weight of the input edge of the transition, and wherein one or more tokens are added in the output place of the transition, the number of which is equal to the weight of the output edge of the transition.

22. The method according to claim 17, wherein each node of the reachability graph is specified by a number of identifiers, wherein each identifier is assigned to an input place or output place of a corresponding transition and describes a number of tokens in the input place or output place, wherein the number of tokens changes during propagation along the Petri net.

23. The method according to claim 16, wherein the reachability graph includes a number of paths, wherein each path contains a set of nodes of the number of nodes that appear in a specified order during propagation along the Petri net.

24. The method according to claim 23, wherein a part of one of the paths overlaps with a part of another one of the paths.

25. A method for recognizing a malfunction of a sensor system using a reachability graph, the method comprising the following steps:
receiving a reachability graph for recognizing a malfunction of a sensor system, for recognizing a malfunction of a sensor system, wherein the sensor system can be operated with software that is configured to execute a number of tasks in a specified order, the reachability graph being generated by:
generating a Petri net, which contains information about the number of tasks of the sensor system software and their order, wherein each task of the number of tasks is described by a respective transition of the Petri net, which is executed by the software when one or more required conditions for the task are fulfilled, and wherein the execution of the task is at least one required condition for the execution of a subsequent task, and wherein the Petri net includes one or more input places, which contain information about the required conditions to execute the task, wherein the one or more input places are connected to the transition of the Petri net by in each case one or more input edges,
initializing the Petri net by an initial marking, by corresponding required conditions for executing at least one or more tasks from the number of tasks of the software being set as fulfilled,
propagating along the Petri net starting from the initial marking by determining those tasks of the software for which the required conditions are fulfilled at each relevant propagation step, and
generating a reachability graph that includes a number of nodes, wherein each node of the nodes includes information about fulfilled required conditions for executing tasks at a relevant propagation step along the Petri net and reflects an operating state of the sensor system, wherein the information contained in the node includes a marking of the Petri net for the relevant propagation step, and wherein the information contained in the first and last node includes the initial marking of the Petri net; and
processing a validation data set using the received reachability graph.

26. The method according to claim 25, wherein the processing of the validation data set by the received reachability graph includes identifying a number of reached nodes in the reachability graph in relation to the validation data set that reflects a number of covered operating states of the sensor system.

27. The method according to claim 26, further comprising:
checking whether the number of reached nodes fulfills a predetermined coverage criterion;
classifying the validation set as a data set that does not recognize a sensor system malfunction, when the number of reached nodes fulfills a predetermined coverage criterion;
wherein the number of reached nodes does not fulfill the predetermined coverage criterion, classifying the validation set as a data set that recognizes a sensor system malfunction.

28. The method according to claim 27, wherein the predetermined coverage criterion includes that the number of reached nodes falls below a predefined threshold value.

29. The method according to claim 25, wherein the processing of the validation data set by the received reachability graph includes identifying a number of reached paths in the reachability graph in relation to the validation data set.

30. A module configured to generate a reachability graph for recognizing a malfunction of a sensor system, wherein the sensor system can be operated with software that is configured to execute a number of tasks in a specified order, the module configured to:
generate a Petri net, which contains information about the number of tasks of the sensor system software and their order, wherein each task of the number of tasks is described by a respective transition of the Petri net, which is executed by the software when one or more required conditions for the task are fulfilled, and wherein the execution of the task is at least one required condition for the execution of a subsequent task, and wherein the Petri net includes one or more input places, which contain information about the required conditions to execute the task, wherein the one or more input places are connected to the transition of the Petri net by in each case one or more input edges;
initialize the Petri net by an initial marking, by corresponding required conditions for executing at least one or more tasks from the number of tasks of the software being set as fulfilled;
propagate along the Petri net starting from the initial marking by determining those tasks of the software for which the required conditions are fulfilled at each relevant propagation step; and
generate a reachability graph that includes a number of nodes, wherein each node of the nodes includes information about fulfilled required conditions for executing tasks at a relevant propagation step along the Petri net and reflects an operating state of the sensor system, wherein the information contained in the node includes a marking of the Petri net for the relevant propagation step, and wherein the information contained in the first and last node includes the initial marking of the Petri net.

31. A sensor system configured to recognizing a malfunction of the sensor system using a reachability graph, the sensor system configured to:
receive a reachability graph for recognizing a malfunction of a sensor system, for recognizing a malfunction of a sensor system, wherein the sensor system can be operated with software that is configured to execute a number of tasks in a specified order, the reachability graph being generated by:
generating a Petri net, which contains information about the number of tasks of the sensor system software and their order, wherein each task of the number of tasks is described by a respective transition of the Petri net, which is executed by the software when one or more required conditions for the task are fulfilled, and wherein the execution of the task is at least one required condition for the execution of a subsequent task, and wherein the Petri net includes one or more input places, which contain information about the required conditions to execute the task, wherein the one or more input places are connected to the transition of the Petri net by in each case one or more input edges,
initializing the Petri net by an initial marking, by corresponding required conditions for executing at least one or more tasks from the number of tasks of the software being set as fulfilled,
propagating along the Petri net starting from the initial marking by determining those tasks of the software for which the required conditions are fulfilled at each relevant propagation step, and
generating a reachability graph that includes a number of nodes, wherein each node of the nodes includes information about fulfilled required conditions for executing tasks at a relevant propagation step along the Petri net and reflects an operating state of the sensor system, wherein the information contained in the node includes a marking of the Petri net for the relevant propagation step, and wherein the information contained in the first and last node includes the initial marking of the Petri net;
generate a validation data set; and
process the validation data set using the received reachability graph.

32. A module configured to:
receive a reachability graph from a first module, the first module configured to generate the reachability graph for recognizing a malfunction of a sensor system, wherein the sensor system can be operated with software that is configured to execute a number of tasks in a specified order, the first module configured to:
generate a Petri net, which contains information about the number of tasks of the sensor system software and their order, wherein each task of the number of tasks is described by a respective transition of the Petri net, which is executed by the software when one or more required conditions for the task are fulfilled, and wherein the execution of the task is at least one required condition for the execution of a subsequent task, and wherein the Petri net includes one or more input places, which contain information about the required conditions to execute the task, wherein the one or more input places are connected to the transition of the Petri net by in each case one or more input edges,
initialize the Petri net by an initial marking, by corresponding required conditions for executing at least one or more tasks from the number of tasks of the software being set as fulfilled,
propagate along the Petri net starting from the initial marking by determining those tasks of the software for which the required conditions are fulfilled at each relevant propagation step, and
generate a reachability graph that includes a number of nodes, wherein each node of the nodes includes information about fulfilled required conditions for executing tasks at a relevant propagation step along the Petri net and reflects an operating state of the sensor system, wherein the information contained in the node includes a marking of the Petri net for the relevant propagation step, and wherein the information contained in the first and last node includes the initial marking of the Petri net;
receive a validation data set from a sensor system; and
process the validation data set using the received reachability graph.
